(19) United States
(12) Patent Application Publication
(10) Pub. No.: US 2022/0254001 A1
(43) Pub. Date: Aug. 11, 2022

(54) IMAGE MEASUREMENT METHOD AND IMAGE MEASUREMENT SYSTEM

(71) Applicant: MITSUBISHI HEAVY INDUSTRIES, LTD., Tokyo (JP)

(72) Inventors: Akitoshi ICHIO, Tokyo (JP); Yukio TAKEUCHI, Tokyo (JP); Yuichi SASANO, Tokyo (JP); Yoshihiro KOKETSU, Tokyo (JP)

(21) Appl. No.: 17/765,712

(22) PCT Filed: Feb. 12, 2020
(86) PCT No.: PCT/JP2020/005280

§ 371 Date: Mar. 31, 2022

(30) Foreign Application Priority Data
Oct. 4, 2019 (JP) 2019-183967

(51) Int. Cl. G06T 7/00; G01B 11/24; G06T 7/73; G06T 7/55

(52) U.S. Cl. CPC G06T 7/001; G01B 11/24; G06T 2207/30164; G06T 7/55; G06T 7/73

(57) ABSTRACT

An image measurement method for performing shape measurement of a component in which measurement points associated with identifiers are set includes: a first step of capturing images of the component to obtain measurement images; a second step of obtaining correspondence data in which the identifiers of the measurement points are associated with the measurement image; a third step of counting the number of measurement images associated with the identifier of each measurement point based on the correspondence data; a fourth step of calculating an evaluation point for each measurement image based on evaluation parameters including the number of measurement images; a fifth step of selecting and removing measurement images based on the calculated evaluation points; and a sixth step of performing the shape measurement of the component by using the measurement images other than the removed measurement images.

### FIELD

The present invention relates to an image measurement method and an image measurement system.

### BACKGROUND

As an image measurement method, image capturing devices for three-dimensional measurement have been known in the art, the image capturing devices measuring the three-dimensional shape of a measurement object by using images of the measurement object captured by an image capturing unit (see, for example, Patent Literature 1). Such image capturing devices for three-dimensional measurement efficiently capture images in the proper quantity while keeping track of the progress of the capturing, thereby suppressing an increase in the number of images captured.

### CITATION LIST

### Patent Literature

Patent Literature 1: Japanese Patent Application Laid-open No. 2010-256253

### SUMMARY

### Technical Problem

To measure the shape of a large component used in an aircraft, measurement points are set on the component, and the shape of the component is measured by measuring the positions of the measurement points. At this time, in Patent Literature 1, images are captured while keeping track of the progress; nevertheless it is difficult to obtain an optimal number of measurement images for each measurement point. Thus, in order to improve the measurement accuracy at a measurement point, a large number of measurement images need to be captured, and it is difficult to suppress an increase in the number of measurement images captured. As a result, when shape measurement is performed using a large number of measurement images in order to improve the measurement accuracy, the processing time involved in the shape measurement increases as the number of measurement images increases.

Therefore, it is an object of the present disclosure to provide an image measurement method and an image measurement system that are capable of reducing the number of measurement images to shorten the processing time involved in shape measurement of a component, while maintaining the measurement accuracy of the shape.

### Solution to Problem

An image measurement method according to the present disclosure is an image measurement method for capturing images of components that are manufactured under an identical standard to perform shape measurement of the components. The shape measurement is performed for each of the components, a plurality of measurement points are set at preset positions of the component, and the plurality of measurement points are associated with a plurality of identifiers. The image measurement method includes: a first step of capturing images of the component to obtain measurement images; a second step of obtaining measurement points included in each obtained measurement image and obtaining correspondence data in which the identifiers of the measurement points are associated with the measurement image; a third step of counting the number of measurement images associated with the identifier of each measurement point based on the obtained correspondence data; a fourth step of calculating an evaluation point for each measurement image based on evaluation parameters including the number of measurement images associated with the identifier; a fifth step of selecting and removing measurement images based on the calculated evaluation points; and a sixth step of performing the shape measurement of the component by using the measurement images other than the removed measurement images.

An image measurement system according to the present disclosure is an image measurement system that captures images of components that are manufactured under an identical standard to perform shape measurement of the components. The shape measurement are performed for each of the components, a plurality of measurement points are set at preset positions of the component, the plurality of measurement points are associated with a plurality of identifiers. The image measurement system includes: an image capturing device that captures the images of the component; a moving unit that moves the image capturing device; and a control unit that obtains the measurement images captured by the image capturing device and performs the shape measurement of the components. The control unit performs: a first step of capturing images of the component to obtain measurement images; a second step of obtaining measurement points included in each obtained measurement image and obtaining correspondence data in which the identifiers of the measurement points are associated with the measurement image; a third step of counting the number of measurement images associated with the identifier of each measurement point based on the obtained correspondence data; a fourth step of calculating an evaluation point for each measurement image based on evaluation parameters including the number of measurement images associated with the identifier; a fifth step of selecting and removing measurement images based on the calculated evaluation points; and a sixth step of performing the shape measurement of the component by using the measurement images other than the removed measurement images.

### Advantageous Effects of Invention

According to the present disclosure, the number of measurement images can be reduced to shorten the processing time involved in shape measurement of a component, while maintaining the measurement accuracy of the shape.

### BRIEF DESCRIPTION OF DRAWINGS

FIG. 1 is a perspective view schematically illustrating an image measurement system according to a first embodiment.

FIG. 2 is a conceptual diagram of capturing images by the image measurement system according to the first embodiment.

FIG. 3 is a block diagram schematically illustrating the image measurement system according to the first embodiment.

FIG. 4 is a flowchart of an image measurement method according to the first embodiment.

FIG. 5 is a conceptual diagram of capturing images by a camera when viewed from a measurement point.

FIG. 6 is a diagram of correspondence data.

FIG. 7 is an explanatory diagram of calculation of evaluation points.

FIG. 8 is a graph associating identifiers of measurement points with the number of measurement images.

FIG. 9 is a flowchart of an image measurement method according to a second embodiment.

FIG. 10 is a diagram a schematically illustrating a display screen.

### DESCRIPTION OF EMBODIMENTS

Embodiments of the present invention will be described below in detail with reference to the drawings. The embodiments are not intended to limit the present invention. Components in the following embodiments include those that are replaceable by a person skilled in the art and easy, or those that are substantially the same. Furthermore, the components described below can be combined as appropriate, and, when there are a plurality of embodiments, the embodiments can be combined.

### First Embodiment

An image measurement method according to a first embodiment is a method of photographing components 3 used in an aircraft, for example, to obtain a plurality of measurement images, and using the obtained measurement images to measure the shape of the components 3. The image measurement method is performed by an image measurement system 1. Here, the components 3 to be measured are manufactured under an identical standard and are mass-produced. Each component 3 is, for example, the airframe of an aircraft, which is a large component. In the image measurement method, the shape of the component 3 is measured repeatedly.

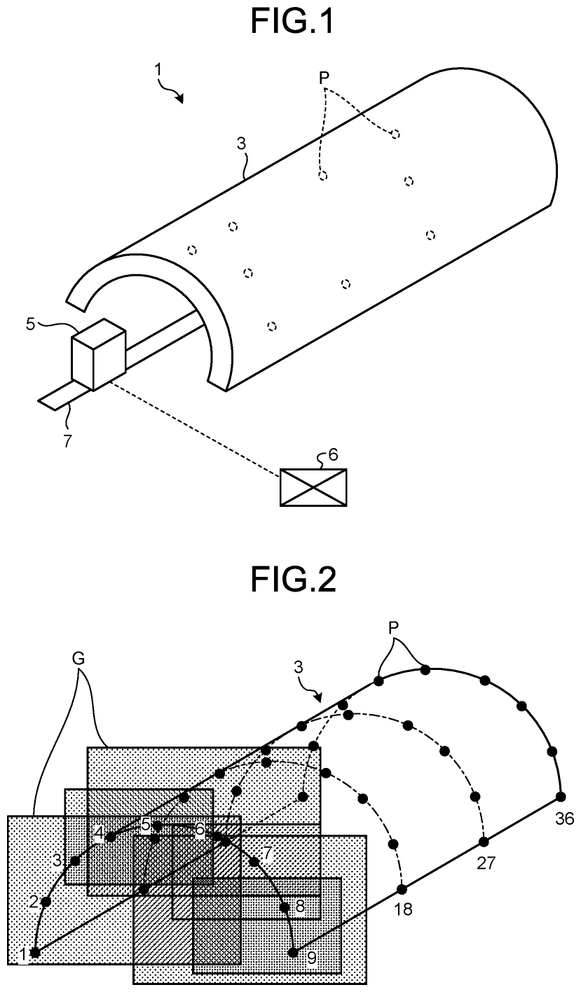

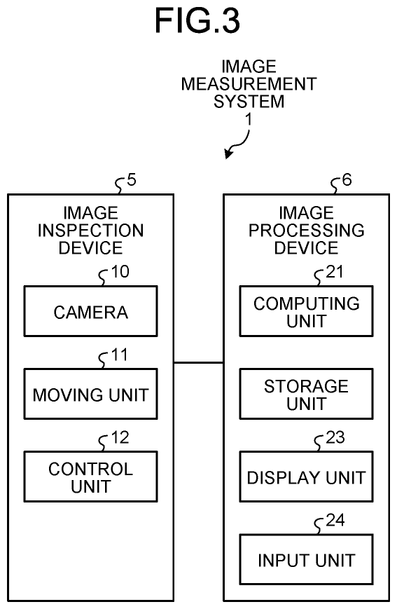

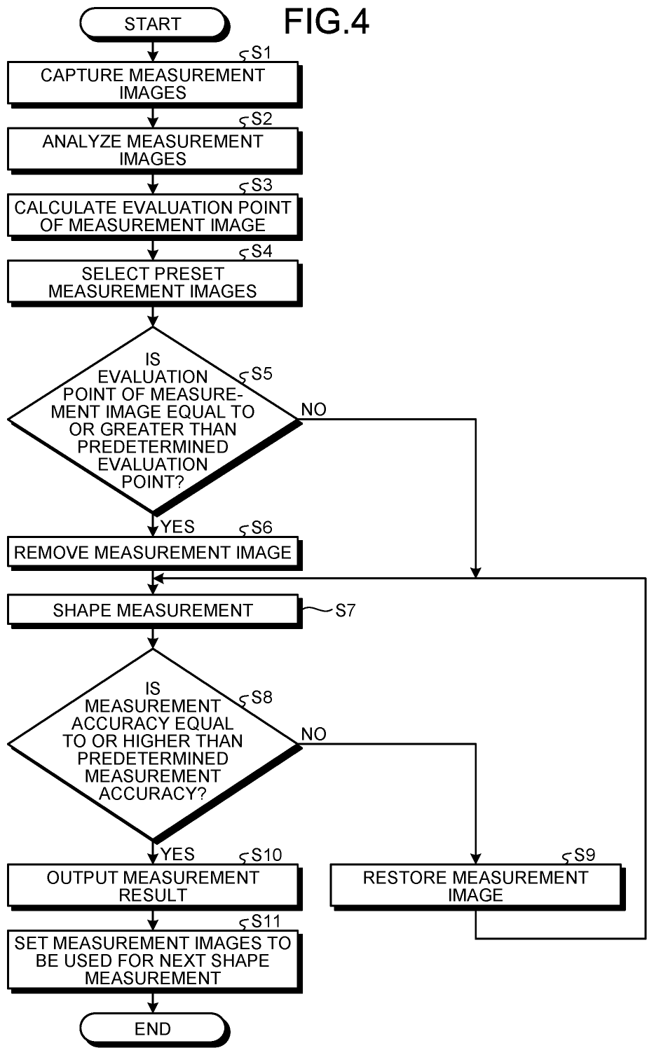

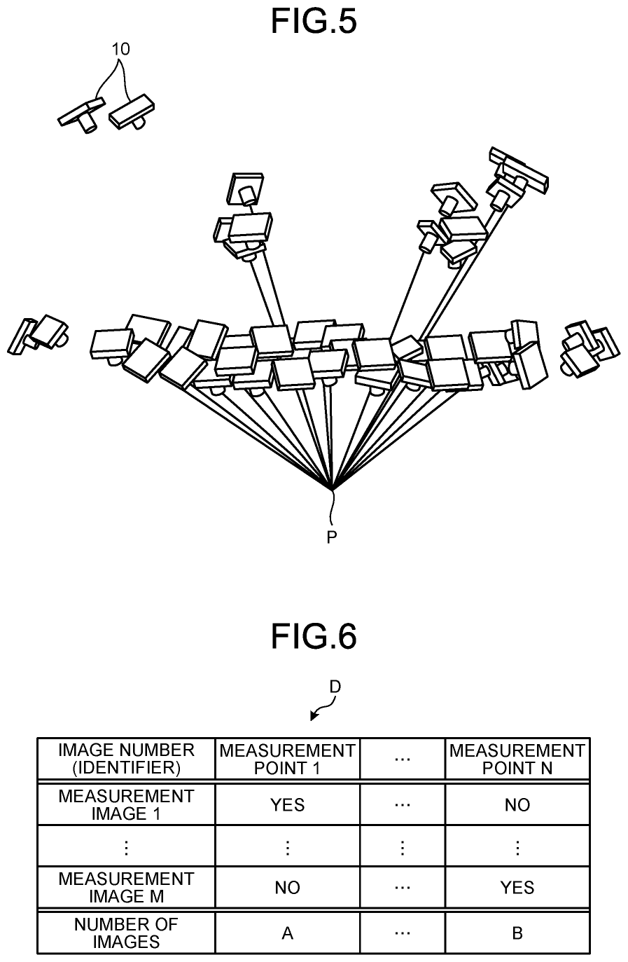

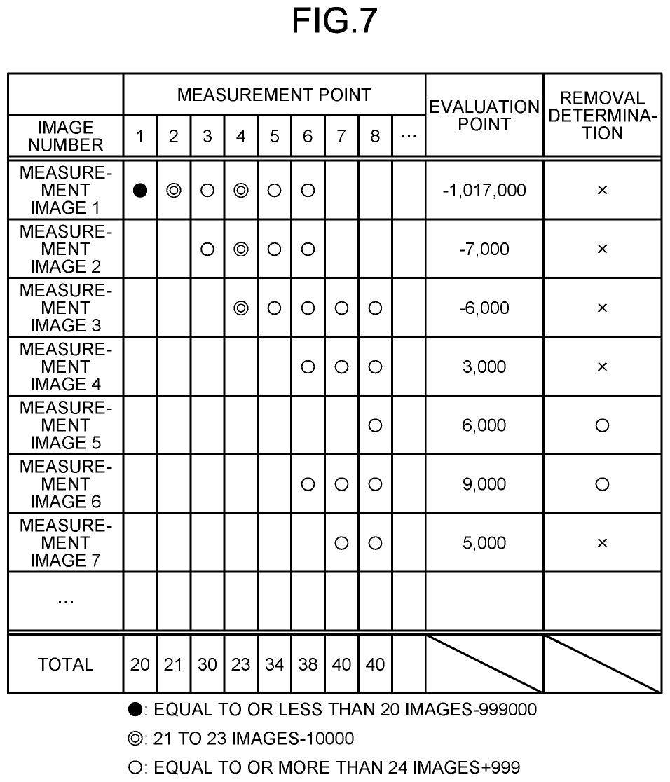

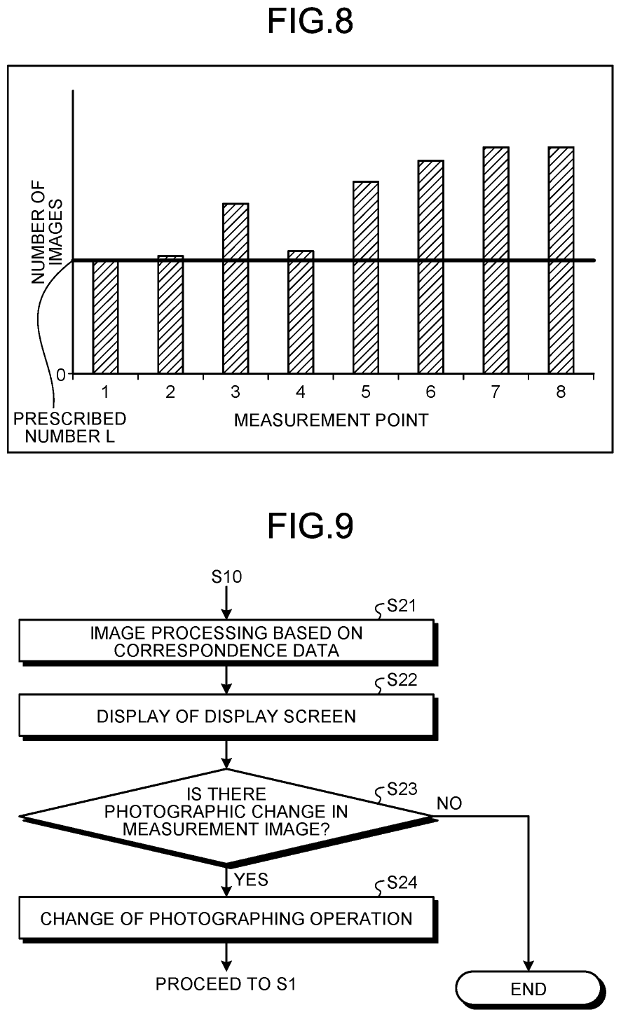

FIG. 1 is a perspective view schematically illustrating the image measurement system according to the first embodiment. FIG. 2 is a conceptual diagram of capturing images by the image measurement system according to the first embodiment. FIG. 3 is a block diagram schematically illustrating the image measurement system according to the first embodiment. FIG. 4 is a flowchart of the image measurement method according to the first embodiment. FIG. 5 is a conceptual diagram of capturing images by a camera when viewed from a measurement point. FIG. 6 is a diagram of correspondence data. FIG. 7 is an explanatory diagram of calculation of evaluation points. FIG. 8 is a graph associating identifiers of measurement points with the number of measurement images.

As illustrated in FIG. 1, the component 3 is, for example, semicylindrical, and has a plurality of measurement points P set in advance at predetermined positions on the inner circumference thereof. A reflective material, such as a reflective sticker, is provided at each of these measurement points P.

Image Measurement System

Next, the image measurement system 1 will be described with reference to FIGS. 1 through 3. The image measurement system 1 includes an image inspection device 5, an image processing device 6, and a rail 7. The image measurement system 1 moves the image inspection device 5 along the rail 7, transmits, to the image processing device 6, a plurality of measurement images obtained by the image inspection device photographing the component 3, and measures the shape of the component 3 with the measurement images by means of the image processing device 6. This image measurement system 1 performs shape measurement using what is called photogrammetry, and generates a three-dimensional (3D) measurement model of the component 3 from the measurement images.

FIG. 2 is a conceptual diagram illustrating the shape measurement performed by the image measurement system 1. FIG. 2 illustrates the schematic component 3, the measurement points P set on the component 3, and measurement images G captured by the image measurement system 1. Each measurement image G is an image of the component 3 including the measurement points P. The measurement image G includes some of the measurement points P while not including the rest of the measurement points P. At this time, the number of measurement images G captured for each measurement point P varies.

FIGS. 1 and 3 are referred to again. The rail 7 guides the movement of the image inspection device 5. The rail 7 is provided inside the semicylindrical component 3, and is disposed in a straight line over the axial direction of the component 3.

The image inspection device 5 moves on the rail 7 to photograph the inner circumference of the component 3. The image inspection device 5 has a camera (image capturing device) 10, a moving unit 11, and a control unit 12. The camera 10 photographs the component 3, which is a photographing target, and generates measurement images G. The photographing operation of the camera 10 is controlled by the control unit 12. The number of cameras 10 is not particularly limited. The moving unit 11 is a mobile object that moves on the rail 7 and is equipped with the camera 10 and the control unit 12. The moving operation of the moving unit 11 is controlled by the control unit 12.

The control unit 12 includes, for example, an integrated circuit, such as a central processing unit (CPU). The control unit 12 controls each part of the image inspection device 5. The control unit 12 controls the photographing operation of the camera 10 and the moving operation of the moving unit 11.

The image processing device 6 obtains the measurement images G captured by the image inspection device 5, generates a measurement model of the component 3, and compares the measurement model with a pre-designed reference design model and calculates the difference to evaluate the shape of the component 3. The image processing device 6 has a computing unit 21, a storage unit 22, a display unit 23, and an input unit 24.

The computing unit 21 includes, for example, an integrated circuit, such as a central processing unit (CPU). The computing unit 21 performs processing for selecting the obtained measurement images G, processing for measuring the shape of the component with the selected measurement images G, and other processing. The storage unit 22 is any storage device, such as a semiconductor storage device and a magnetic storage device. This storage unit 22 stores therein various computer programs for executing various processing and various data used for the processing. The various data includes, for example, image data of the measurement images G and correspondence data D, which will be described later. The display unit 23 is, for example, a display device, such as a liquid crystal display. The input unit 24 is, for example, an input device, such as a keyboard and a mouse. The display unit 23 and the input unit 24 may be integrated as an input display device that can be operated by a touch panel or other input devices.

Image Measurement Method

Next, the image measurement method using the image measurement system 1 will be described with reference to FIG. 4. This image measurement method reduces the number of measurement images G used for shape measurement by selecting any measurement image(s) G from a plurality of obtained measurement images G, and measures the shape of the component 3 with the selected measurement image(s) G.

First, the image measurement system 1 moves the image inspection device 5 along the rail 7, and captures a plurality of measurement images G with the camera 10 of the image inspection device 5 (step S1: the first step). At step S1, the image inspection device 5 captures a plurality of measurement images G over the entire length of the component 3 in the axial direction, from one end to the other end of the component 3 in the axial direction. At the time of capturing the images, the image inspection device 5 associates a plurality of image numbers with the captured measurement images G. The image inspection device 5 then transmits, to the image processing device 6, the measurement images G with the image numbers assigned to.

Here, the captured measurement images G each include a plurality of measurement points P. FIG. 5 is a diagram illustrating photographing positions of the camera 10 when viewed from a measurement point P. As illustrated in FIG. 5, a predetermined measurement point P is photographed a plurality of times by the camera 10 at different photographing positions of the camera 10, and a plurality of measurement images G including the measurement point P are thus obtained.

Subsequently, the image measurement system 1 analyzes the obtained measurement images G in the image processing device 6 (step S2). At step S2, the step of generating and obtaining the correspondence data D illustrated in FIG. 6 (the second step) and the step of counting the number of measurement images G at the measurement point P on the basis of the obtained correspondence data D (the third step) are performed.

The correspondence data D will be described with reference to FIG. 6. Here, each measurement point P is assigned with an identifier, for example, measurement point 1, measurement point 2, . . . , measurement point N as an identifier. In the correspondence data D, the image number of the corresponding measurement image G (measurement image 1 to measurement image M) is associated with the identifier of each measurement point P. In the correspondence data D, the number of measurement images G at each measurement point P is also associated.

At the second step, the measurement points P included in the obtained measurement images are obtained, and the identifiers of the measurement points P are associated with the corresponding measurement images G. In other words, for “measurement image 1”, when “measurement point 1” is included in the image, it is associated as “Yes”, while, when “measurement point N” is not included in the image, it is associated as “No”.

At the third step, the number of measurement images G associated with the identifier of the measurement point P is counted on the basis of the associated correspondence data D. In other words, for “measurement point 1”, “A” is obtained by counting the number of measurement images that are “Yes”, and “A” is associated with “measurement point 1”. For “measurement point N”, “B” is obtained by counting the number of measurement images G that are “Yes”, and “B” is associated with “measurement point N”.

Next, the image measurement system 1 calculates an evaluation point of the measurement image G on the basis of the generated correspondence data D in the image processing device 6 (step S3: the fourth step). At step S3, the number of measurement images G associated with the identifier of the measurement point P is used as one of evaluation parameters, and the evaluation point of the measurement image G is calculated by an evaluation formula including the evaluation parameter. The evaluation formula is, for example, a formula in which, for each measurement point P included in the measurement image G, a weighting based on the number of measurement images included in the measurement point P is set and the weighting for each measurement point P is totaled for all the measurement points P. Here, the evaluation formula is weighted to lower the evaluation point when the number of measurement images associated with the identifiers of the measurement points P is small, and is weighted to raise the evaluation point when the number of measurement images associated with the identifiers of the measurement points is large. As a result, a measurement image having a higher evaluation point is to be deleted.

The calculation of evaluation points will be described in detail with reference to FIGS. 7 and 8. In the table illustrated in FIG. 7, the image number of the measurement image G, the identifier of the measurement point P, the weighting, the removal determination, and the evaluation point are associated with each other. The identifier of each measurement point P on each measurement image G is weighted according to the number of measurement images G associated with the measurement point P. Weightings are, for example, a filled circle (•), a double circle (⊚), and an open circle (∘), and are divided according to the number of measurement images G, as illustrated in FIG. 8. The weighting of the measurement points P that are not included in the measurement image G is blank.

In the graph illustrated in FIG. 8, the horizontal axis is the identifier (measurement point 1, measurement point 2 . . . ) of the measurement point P, and the vertical axis is the number of measurement images G. As illustrated in FIG. 8, the number of measurement images G associated with each measurement point P varies. A line L in FIG. 8 is the prescribed number that is the bare minimum of images to measure the position of the measurement point P. The evaluation points of measurement images G are calculated in such a way that the number of measurement images G at each measurement point P is not equal to or less than the prescribed number.

When the number of images is equal to or less than the prescribed number (20), a filled circle (•) is assigned for weighting, and a score of “−999000” is set. When the number of images is more than the prescribed number (21) and less than a predetermined number (24), that is (23), a double circle (⊚) is assigned for weighting, and a score of “−10000” is set. When the number of images is equal to or more than the predetermined number (24), an open circle (∘) is assigned for weighting, and a score of “+999” is set. The evaluation point of the measurement image G is then calculated by totaling the scores of the weighted measurement points P.

Thereafter, the image measurement system 1 selects preset measurement images G in the image processing device 6 (step S4). At step S4, measurement images G that were set as to be deleted and measurement images G that were set as to be restored in the previous shape measurement are selected.

Subsequently, the image measurement system 1 selects measurement images G on the basis of the calculated evaluation points in the image processing device 6 (step S5). Specifically, at step S5, it is determined whether the evaluation point of each measurement image G is equal to or greater than a predetermined evaluation point, which is a preset threshold value. At step S5, if it is determined that the evaluation point of the measurement image G is equal to or greater than the predetermined evaluation point (Yes at step S5), the image processing device 6 removes the measurement image G (step S6: the fifth step). At step S5, if it is determined that the evaluation point of the measurement image G is smaller than the predetermined evaluation point (No at step S5), the image processing device 6 does not remove the measurement image G. The determination results at step S5 may be associated with the image numbers of the measurement images G in the table illustrated in FIG. 7.

Thereafter, the image measurement system 1 measures the shape of the component 3 with the selected measurement images G in the image processing device 6 (step S7: the sixth step). Specifically, at step S7, a three-dimensional measurement model of the component 3 is generated using the measurement images G.

Subsequently, the image measurement system 1 determines whether the error in the generation of the measurement model, that is, the measurement accuracy, is equal to or higher than predetermined measurement accuracy, which is a preset threshold value, in the image processing device 6 (step S8: the seventh step). At step S8, if it is determined that the measurement accuracy is equal to or higher than the predetermined measurement accuracy (Yes at step S8), the image processing device 6 outputs the measurement result (step S10). If it is determined that the measurement accuracy is lower than the predetermined measurement accuracy (No at step S8), the image processing device 6 restores the corresponding measurement image G (step S9: the ninth step).

At step S9, the image processing device 6 selects measurement images G to be restored, in decreasing order of the number of measurement points P included in the measurement images G, on the basis of the correspondence data. The number of measurement images to be restored at step S9 is not particularly limited, and may be one or more. After performing step S9, the image measurement system 1 performs step S7 again. Consequently, the image measurement system 1 performs step S9 until the measurement accuracy becomes equal to or higher than the predetermined measurement accuracy.

The image measurement system 1 outputs the difference calculated by comparing the generated measurement model with the design model as the measurement result output at step S10. The image measurement system 1 also displays, on the display unit 23 of the image processing device 6, an image obtained by superimposing the measurement model and the design model on top of one another, as the measurement result.

The image measurement system 1 then sets the measurement images G after removal and restoration used for the shape measurement as the measurement images G to be used for the next shape measurement, on the basis of the measurement images G removed at step S6 and the measurement images G restored at step S9 (step S11: the eighth step). In other words, at step S11, the removed measurement images G can be set not to be adopted and the restored measurement images G can be set to be adopted at the next shape measurement. The measurement images G set at step S11 are the measurement images G to be selected at step S4. After performing step S11, the image measurement system 1 finishes the process related to the image measurement method.

As described above, according to the first embodiment, the shape of the component 3 can be measured by removing unnecessary measurement images G that do not deteriorate the measurement accuracy and using the rest of the measurement images G excluding the removed measurement images G. As a result, the number of measurement images used for shape measurement can be reduced, which can shorten the processing time involved in the shape measurement.

According to the first embodiment, since the evaluation points are calculated by weighting the number of measurement images G, the removal of measurement images G having a small number of images can be restrained, and the deterioration of measurement accuracy in shape measurement can be restrained.

According to the first embodiment, when the measurement accuracy in shape measurement can be ensured, the removed measurement images G can be set not to be adopted in the next shape measurement. This setting enables the shape measurement to be performed with a reduced number of measurement images G in the next shape measurement, thereby shortening the processing time involved in the shape measurement.

According to the first embodiment, when the measurement accuracy deteriorates, the measurement images G can be restored, thus restraining the deterioration of the measurement accuracy of shape measurement.

According to the first embodiment, the measurement accuracy can be ensured by restoring a small number of measurement images G by restoring the images in decreasing order of the number of measurement points P included in the images, as the measurement images G to be restored.

When it has been determined not to adopt the removed measurement images G in the first embodiment, photographing of the removed measurement images G can be omitted in photographing measurement images G.

As the measurement images G to be restored, the measurement images G have been restored in decreasing order of the number of measurement points P included in the images, but restoration is not limited to this configuration. For example, as the measurement images G to be restored, the measurement images G may be restored in ascending order of the evaluation point.

### Second Embodiment

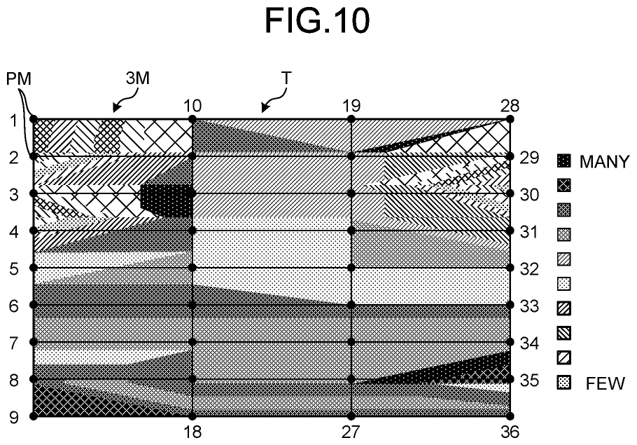

Next, an image measurement method and the image measurement system 1 according to a second embodiment will be described with reference to FIGS. 9 and 10. In order to avoid duplicate descriptions, parts of the second embodiment that are different from those of the first embodiment will be described, and parts that have the same configuration as the first embodiment will be described with the same reference signs assigned to. FIG. 9 is a flowchart of the image measurement method according to the second embodiment. FIG. 10 is a diagram a schematically illustrating a display screen.

The image measurement method of the second embodiment follows the flowchart illustrated in FIG. 9 in addition to the image measurement method of the first embodiment.

After performing step S10, the image measurement system 1 performs image processing to generate a display screen T to be displayed on the display unit 23 of the image processing device 6 on the basis of the correspondence data D (step S21). Here, as illustrated in FIG. 10, the display screen T displays a measurement model (component model) 3M that has modeled the component 3 generated during shape measurement, and a measurement point model PM of the measurement points P set in the measurement model. On this display screen T, a plurality of square compartments are displayed by the measurement model 3M and the measurement point model PM, and the compartments are arranged in gridlike fashion. In these compartments, the number of measurement images G associated with each measurement point P is set on the basis of the correspondence data D. The display form of the number of measurement images G associated with the measurement point model PM is not limited to the above; for example, the number of measurement images G may be displayed using contour lines. In other words, with the measurement point model PM at the center, the number of contour lines may be displayed in such a way that the number of contour lines increases with more images, and the number of contour lines decreases with fewer images. In this manner, at step S21, the image processing device 6 performs the image processing to generate the display screen T illustrated in FIG. 10 on the basis of the correspondence data D.

Thereafter, the image measurement system 1 causes the display unit 23 of the image processing device 6 to display the display screen T (step S22: the tenth step). An operator can view this display screen T and optionally change photographing conditions, such as the photographing position of the component 3, by operating the input unit 24. The image processing device 6 determines whether there is any change in the photographing conditions including the photographing position of the measurement image G on the basis of the information input from the input unit 24 (step S23). If the image processing device 6 determines that there is a change in the photographing conditions (Yes at step S23), the image processing device 6 changes the photographing operation of the image inspection device 5 (step S24: the eleventh step). Thereafter, the image measurement system 1 proceeds to step S1 and performs step S1 on the basis of the changed photographing operation. If the image processing device 6 determines that there is no change in the photographing conditions (No at step S23), the image processing device 6 finishes the process related to the image measurement method.

Here, the change in photographing conditions includes the photographing position of the camera 10 and the posture of the camera 10. The photographing position of the camera 10 includes the distance between the camera 10 and the measurement point P and the photographing angle of the camera 10 relative to the measurement point P. The posture of the camera 10 includes the tilt angle in each axis of a 3-axis gimbal. By viewing the display screen T, the operator can make a photographic change to capture additional images, change the photographing position of the camera 10, or change the posture of the camera 10 so that more measurement images G are captured for the measurement point P for which the number of measurement images G is small.

As described above, according to the second embodiment, the number of measurement images G is displayed on the display screen T with the number of measurement images G associated with the measurement point model PM, which makes it possible to grasp whether there is an imbalance in the number of measurement images G for the measurement point P.

According to the second embodiment, when there is an imbalance in the number of measurement images G, appropriate measurement images G can be obtained for the measurement point P by changing the photographing conditions as appropriate.

In the second embodiment, the photographing conditions of the camera 10 for the measurement point P are changed. However, in calculating the evaluation point of the measurement image G, the photographing conditions of the measurement image G associated with the measurement point P may be included as evaluation parameters. In other words, in addition to the number of measurement images G, the photographing position of the camera 10 and the posture of the camera 10 may be included as evaluation parameters in the evaluation formula. With this configuration, the scores of the evaluation points for the measurement images G can be calculated more appropriately.

The image measurement methods and the image measurement system 1 described in the embodiments are understood, for example, as follows.

An image measurement method according to a first aspect is an image measurement method for capturing images of components 3 that are manufactured under an identical standard to perform shape measurement of the components 3, in which the shape measurement is performed for each of the components 3, a plurality of measurement points are set at preset positions of the component 3, and the plurality of measurement points are associated with a plurality of identifiers. The image measurement method includes: a first step (step S1) of capturing images of the component 3 to obtain measurement images G; a second step (step S2) of obtaining measurement points P included in each obtained measurement image G and obtaining correspondence data D in which the identifiers of the measurement points P are associated with the measurement image G; a third step (step S2) of counting the number of measurement images G associated with the identifier of each measurement point P based on the obtained correspondence data D; a fourth step (step S3) of calculating an evaluation point for each measurement image G based on evaluation parameters including the number of measurement images G associated with the identifier; a fifth step (step S6) of selecting and removing measurement images G based on the calculated evaluation points; and a sixth step (step S7) of performing the shape measurement of the component 3 by using the measurement images G other than the removed measurement images G.

With this configuration, the shape of the component 3 can be measured by removing unnecessary measurement images G that do not deteriorate the measurement accuracy and using the rest of the measurement images G excluding the removed measurement images G. As a result, the number of measurement images used for shape measurement can be reduced, which can shorten the processing time involved in the shape measurement.

As a second aspect, the evaluation point of the measurement image G is calculated using an evaluation formula including the evaluation parameters, the evaluation formula is weighted to lower the evaluation point when the number of measurement images G associated with the identifier of each measurement point P is small, and the evaluation formula is weighted to raise the evaluation point when the number of measurement images G associated with the identifier of each measurement point P is large.

With this configuration, since the evaluation points are calculated by weighting the number of measurement images G, the removal of measurement images G having a small number of images can be restrained, and the deterioration of measurement accuracy in shape measurement can be restrained.

As a third aspect, the evaluation parameters of the evaluation formula include a photographing condition of the measurement image G associated with the identifier of the measurement point P.

With this configuration, the scores of the evaluation points for the measurement images G can be calculated more appropriately.

As a fourth aspect, the image measurement method includes: a seventh step (step S8) of evaluating measurement accuracy of the shape measurement at the sixth step and determining whether the measurement accuracy is equal to or higher than predetermined measurement accuracy; and an eighth step (step S11) of, when the measurement accuracy is determined to be equal to or higher than the predetermined measurement accuracy, setting that the measurement images G removed at the fifth step are not adopted in performing the shape measurement at the next sixth step.

With this configuration, when the measurement accuracy in shape measurement can be ensured, the removed measurement images G can be set not to be adopted in the next shape measurement. This setting enables the shape measurement to be performed with a reduced number of measurement images G in the next shape measurement, thereby shortening the processing time involved in the shape measurement.

As a fifth aspect, the image measurement method further includes a ninth step (step S9) of, when the measurement accuracy is determined to be lower than the predetermined measurement accuracy at the seventh step, restoring the measurement images G removed at the fifth step. The sixth step includes performing the shape measurement of the component by using the measurement images G including the restored measurement images G.

With this configuration, when the measurement accuracy deteriorates, the measurement images G can be restored, thus restraining the deterioration of the measurement accuracy of shape measurement.

As a sixth aspect, the ninth step (step S9) includes restoring the measurement images G in decreasing order of the number of measurement points included in the measurement image G, based on the correspondence data D.

With this configuration, the measurement accuracy can be ensured by restoring a small number of measurement images G by restoring the images in decreasing order of the number of measurement points P included in the images, as the measurement images G to be restored.

As a seventh aspect, the image measurement method further includes a tenth step (step S22) of causing a display unit 23 to display a display screen T on which a result of photographing the component 3 is displayed. The display screen T displays a component model (component model) 3M in which the component 3 is modeled, and displays a measurement point model PM of the measurement points set in the component model 3M. The tenth step (step S22) includes displaying the numbers of measurement images G and the measurement point model PM in association with each other in the display screen T, based on the correspondence data D.

With this configuration, it is easy to grasp whether there is an imbalance in the number of measurement images G for the measurement point P.

As an eighth aspect, the image measurement method further includes an eleventh step (step S24) of changing, based on the number of measurement images G associated with the identifier of each measurement point P, photographing conditions for the measurement points P of the component 3. The first step (step S1) includes capturing images of the component 3 based on the photographing conditions changed at the eleventh step (step S24).

With this configuration, appropriate measurement images can be obtained for the measurement point P by changing the photographing condition as appropriate.

An image measurement system 1 according to a ninth aspect is an image measurement system that captures images of components 3 that are manufactured under an identical standard to perform shape measurement of the components 3, in which the shape measurement is performed for each of the components, a plurality of measurement points P are set at preset positions of the component 3, and the plurality of measurement points P are associated with a plurality of identifiers. The image measurement system includes: an image capturing device (camera 10) that captures the images of the component 3; a moving unit 11 that moves the image capturing device (camera 10); and a control unit (computing unit 21) that obtains the measurement images G captured by the image capturing device (camera 10) and performs the shape measurement of the components 3. The control unit (computing unit 21) performs: a first step (step S1) of capturing images of the component 3 to obtain measurement images G; a second step (step S2) of obtaining measurement points P included in each obtained measurement image G and obtaining correspondence data D in which the identifiers of the measurement points P are associated with the measurement image G; a third step (step S2) of counting the number of measurement images G associated with the identifier of each measurement point P based on the obtained correspondence data D; a fourth step (step S3) of calculating an evaluation point for each measurement image G based on evaluation parameters including the number of measurement images G associated with the identifier; a fifth step (step S6) of selecting and removing measurement images G based on the calculated evaluation points; and a sixth step (step S7) of performing the shape measurement of the component 3 by using the measurement images G other than the removed measurement images G.

With this configuration, the shape of the component 3 can be measured by removing unnecessary measurement images G that do not deteriorate the measurement accuracy and using the rest of the measurement images G excluding the removed measurement images G. As a result, the number of measurement images used for shape measurement can be reduced, which can shorten the processing time involved in the shape measurement.

### REFERENCE SIGNS LIST

1 Image measurement system
3 Component
5 Image inspection device
6 Image processing device
7 Rail
10 Camera
11 Moving unit
12 Control unit
21 Computing unit
22 Storage unit
23 Display unit
24 Input unit
P Measurement point
G Measurement image

1. An image measurement method for capturing images of components that are manufactured under an identical standard to perform shape measurement of the components, the shape measurement being performed for each of the components, a plurality of measurement points being set at preset positions of the component, the plurality of measurement points being associated with a plurality of identifiers,
the image measurement method comprising:
capturing images of the component to obtain measurement images;
obtaining measurement points included in each obtained measurement image and obtaining correspondence data in which the identifiers of the measurement points are associated with the measurement image;
counting the number of measurement images associated with the identifier of each measurement point based on the obtained correspondence data;
calculating an evaluation point for each measurement image based on evaluation parameters including the number of measurement images associated with the identifier;
selecting and removing measurement images based on the calculated evaluation points; and
performing the shape measurement of the component by using the measurement images other than the removed measurement images.

2. The image measurement method according to claim 1, wherein
the evaluation point of the measurement image is calculated using an evaluation formula including the evaluation parameters,
the evaluation formula is weighted to lower the evaluation point when the number of measurement images associated with the identifier of each measurement point is small, and
the evaluation formula is weighted to raise the evaluation point when the number of measurement images associated with the identifier of each measurement point is large.

3. The image measurement method according to claim 2, wherein the evaluation parameters of the evaluation formula include a photographing condition of the measurement image associated with the identifier of the measurement point.

4. The image measurement method according to claim 1, further comprising:
evaluating measurement accuracy of the shape measurement and determining whether the measurement accuracy is equal to or higher than predetermined measurement accuracy; and
setting, when the measurement accuracy is determined to be equal to or higher than the predetermined measurement accuracy, that the removed measurement images are not adopted in performing the shape measurement at the next sixth step.

5. The image measurement method according to claim 4, further comprising restoring, when the measurement accuracy is determined to be lower than the predetermined measurement accuracy, the removed measurement images, wherein
performing the shape measurement includes using the measurement images including the restored measurement images to perform the shape measurement.

6. The image measurement method according to claim 5, wherein restoring the removed measurement images includes restoring the measurement images in decreasing order of the number of measurement points included in the measurement image, based on the correspondence data.

7. The image measurement method according to claim 1, further comprising causing a display unit to display a display screen on which a result of photographing the component is displayed, wherein
the display screen displays a component model in which the component is modeled, and displays a measurement point model of the measurement points set in the component model, and
causing the display unit to display the display screen includes displaying the numbers of measurement images and the measurement point model in association with each other in the display screen, based on the correspondence data.

8. The image measurement method according to claim 1, further comprising changing, based on the number of measurement images associated with the identifier of each measurement point, photographing conditions for the measurement points of the component, wherein
capturing images of the component includes capturing images of the component based on the changed photographing conditions changed at the eleventh step.

9. An image measurement system that captures images of components that are manufactured under an identical standard to perform shape measurement of the components, the shape measurement being performed for each of the components, a plurality of measurement points being set at preset positions of the component, the plurality of measurement points being associated with a plurality of identifiers,
the image measurement system comprising:
an image capturing device that captures the images of the component;
a moving unit that moves the image capturing device; and
a control unit that obtains the measurement images captured by the image capturing device and performs the shape measurement of the components, wherein
the control unit performs:
capturing images of the component to obtain measurement images;
obtaining measurement points included in each obtained measurement image and obtaining correspondence data in which the identifiers of the measurement points are associated with the measurement image;
counting the number of measurement images associated with the identifier of each measurement point based on the obtained correspondence data;
calculating an evaluation point for each measurement image based on evaluation parameters including the number of measurement images associated with the identifier;
selecting and removing measurement images based on the calculated evaluation points; and
performing the shape measurement of the component by using the measurement images other than the removed measurement images.
